(19) United States
(12) Patent Application Publication
(10) Pub. No.: US 2024/0151809 A1
(43) Pub. Date: May 9, 2024

(54) METHOD AND APPARATUS SPECIFYING AN OBJECT

(71) Applicant: SAMSUNG ELECTRONICS CO., LTD., Suwon-si (KR)

(72) Inventors: Junyan BAO, Nanjing (CN); Weiyi Gu, Nanjing (CN); Jie Fan, Nanjing (CN); Leiming Li, Nanjing (CN)

(73) Assignee: SAMSUNG ELECTRONICS CO., LTD., Suwon-si (KR)

(21) Appl. No.: 18/417,622

(22) Filed: Jan. 19, 2024

Related U.S. Application Data
(63) Continuation of application No. PCT/KR2022/008819, filed on Jun. 22, 2022.

(30) Foreign Application Priority Data
Jul. 20, 2021 (CN) 202110820526.4

(51) Int. Cl. G01S 5/14

(52) U.S. Cl. CPC G01S 5/14

(57) ABSTRACT

A method for specifying an object, includes: determining whether a pointing device is in a pointing mode or a control mode; determining a first position of a first locator and a second position of a second locator in the pointing device in a virtual space, when the pointing device is in the pointing mode; determining a pointing of the pointing device based on the first position of the first locator and the second position of the second locator; and determining a specified virtual object based on the pointing of the pointing device.

### CROSS-REFERENCE TO RELATED APPLICATIONS

This application is a by-pass continuation application of International Application No. PCT/KR2022/008819, filed on Jun. 22, 2022, which is based on and claims priority to Chinese Patent Application No. 202110820526.4, filed on Jul. 20, 2021, in the National Intellectual Property Administration of P.R. China, the disclosures of which are incorporated by reference herein their entireties.

### BACKGROUND

### 1. Field

The disclosure relates to a field of artificial intelligence (AI), and in particular, relates to a method, an apparatus and a system for specifying an object.

### 2. Description of Related Art

It may be implemented in the related art that the capture of user actions in virtual space is implemented through various sensors (such as acceleration sensor, angular velocity sensor, etc.), and the interaction with various objects (for example, virtual objects) is implemented through an apparatus. there are already corresponding products (for example, Spen™ of Samsung) that may perform suspended operation on a smart apparatus, the moving direction of Spen™ may be determined through magnetic induction, and the apparatus may be operated by a preset moving direction.

Although in the current three-dimensional (3D) virtual space, the capture of the user actions may be implemented through the sensors and intentions of the user may be determined through the user actions, the accuracy of the sensors is low and the use is very inconvenience, and more importantly, this method using the sensors is only for a single virtual object or a whole virtual space. If there are many virtual objects in the virtual space, it is difficult for the user to choose one of them for interactive operation, and thus it is impossible to achieve a single precise direction, thereby reducing the immersion of 3D virtual space.

In addition, the hovering operation may only achieve the overall operation on the smart apparatus (for example, sliding a screen to the left to switch the screen), but may not precisely point to a certain link or application in the screen from a great distance for a single interaction, which greatly reduces the expansion of the hovering operation function.

### SUMMARY

According to an aspect of the disclosure, a method for specifying an object, includes: determining whether a pointing device is in a pointing mode or a control mode; determining a first position of a first locator and a second position of a second locator in the pointing device in a virtual space, when the pointing device is in the pointing mode; determining a pointing of the pointing device based on the first position of the first locator and the second position of the second locator; and determining a specified virtual object based on the pointing of the pointing device.

The determining the pointing of the pointing device may include determining a direction in which a connecting line between the first position of the first locator and the second position of the second locator extends along a pointing end of the pointing device, as the pointing of the pointing device, and wherein the determining the specified virtual object may include determining the virtual object located in the direction of the pointing device as the specified virtual object.

The determining the first position of the first locator and the second position of the second locator in the pointing device in the virtual space may include determining the first position of the first locator and the second position of the second locator in a preset coordinate system, respectively, based on a first distance between the first locator and a locating device in a predetermined position in the virtual space and a second distance between the second locator and the locating device.

The locating device may include a ultra wideband (UWB) receiver or a UWB chip, wherein both of the first locator and the second locator may include a UWB transmitter, and wherein the determining the first position of the first locator and the second position of the second locator in the preset coordinate system may include determining a first coordinate of the first locator and a second coordinate of the second locator in the preset coordinate system, respectively, based on a first transmission delay of a data communication between the first locator and the locating device and a second transmission delay of the data communication between the second locator and the locating device.

A first vector between the first locator and the second locator may be determined based on the first coordinate of the first locator and the second coordinate of the second locator in the preset coordinate system.

The determining the specified virtual object may include: determining a second vector between one of the first locator and the second locator and a virtual object in the virtual space; determining an angle between the second vector and the first vector; and determining the virtual object of which the angle with the first vector is within a preset range as the specified virtual object.

The method may further include: determining whether the pointing device is switched to the control mode, when the virtual object is specified; and based on a determination that the pointing device is switched to the control mode and based on a controlling operation of the pointing device, performing a corresponding operation on the virtual object specified by the pointing device.

According to an aspect of the disclosure, a pointing device includes: a first locator; a second locator; and a mode controller configured to control the pointing device to selectively operate in a pointing mode for specifying a virtual object in a virtual space and a control mode for controlling operation of the virtual object specified by the pointing device, wherein pointing of the pointing device is determined based on positions of the first locator and the second locator in the virtual space.

According to an aspect of the disclosure, a specifying system includes: a pointing device comprising a first locator and a second locator; and a processor configured to: determine whether the pointing device is in a pointing mode or a control mode, determine a first position of the first locator and a second position of the second locator in a virtual space, when the pointing device is in the pointing mode, determine a pointing of the pointing device based on the first position of the first locator and the second position of the second locator, and determine a specified virtual object based on the pointing of the pointing device.

The processor may be further configured to: determine a direction in which a connecting line between the first position of the first locator and the second position of the second locator extends along a pointing end of the pointing device, as the pointing of the pointing device, and determine a virtual object located in the direction of the pointing device as the specified virtual object.

The processor may be further configured to determine the first position of the first locator and the second position of the second locator in a preset coordinate system, respectively, based on a first distance between the first locator and a locating device in a predetermined position in the virtual space and a second distance between the second locator and the locating device.

The locating device may include a ultra wideband (UWB) receiver or a UWB chip, wherein both of the first locator and the second locator may include a UWB transmitter, and wherein the processor may be further configured to determine a first coordinate of the first locator and a second coordinate of the second locator in the preset coordinate system, respectively, based on a first transmission delay of data communication between the first locator and the locating device and a second transmission delay between the second locator and the locating device.

A first vector between the first locator and the second locator may be determined based on the first coordinate of the first locator and the second coordinate of the second locator in the preset coordinate system.

When the virtual object is specified by the pointing device, the processor may be configured to determine whether the pointing device is switched to the control mode, and wherein, based on a determination that the pointing device is switched to the control mode and based on a controlling operation of the pointing device, the processor may be further configured to perform a corresponding operation on the virtual object specified by the pointing device.

According to an aspect of the disclosure, a non-transitory computer-readable storage medium may store computer program instructions that when executed by a processor, causing the processor to implement the method.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a block diagram illustrating a specifying system according to an example embodiment of the disclosure;

FIG. 2 is a block diagram illustrating a pointing device according to an example embodiment of the disclosure;

FIG. 3 is a diagram illustrating an example configuration of the pointing device according to an example embodiment of the disclosure;

FIG. 4 is a diagram illustrating a coordinate system according to an example embodiment of the disclosure;

FIG. 5 is a diagram illustrating determining coordinates of a first locator according to an example embodiment of the disclosure;

FIG. 6 is a diagram illustrating determining a distance between the first locator and a locating device according to an example embodiment of the disclosure;

FIG. 7 is a diagram illustrating determining a specified virtual object according to an example embodiment of the disclosure;

FIG. 8 is a diagram illustrating that the pointing device according to an example embodiment of the disclosure is moved;

FIG. 9 is an example diagram illustrating that the specifying system according to an example embodiment of the disclosure is applied to an augmented reality (AR) scene experience;

FIG. 10 is an example diagram illustrating that the specifying system according to an example embodiment of the disclosure is applied to an smart apparatus; and

FIG. 11 is a flowchart illustrating a method of specifying an object according to an example embodiment of the disclosure.

### DETAILED DESCRIPTION

Example embodiments of the disclosure described below in conjunction with accompanying drawings.

The term “couple” and the derivatives thereof refer to any direct or indirect communication between two or more elements, whether or not those elements are in physical contact with each other. The terms “transmit”, “receive”, and “communicate” as well as the derivatives thereof encompass both direct and indirect communication. The terms “include” and “comprise”, and the derivatives thereof refer to inclusion without limitation. The term “or” is an inclusive term meaning “and/or”. The phrase “associated with,” as well as derivatives thereof, refer to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” refers to any device, system, or part thereof that controls at least one operation. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of A, B, and C” includes any of the following combinations: A, B, C, A and B, A and C, B and C, and A and B and C, and any variations thereof. The expression “at least one of a, b, or c” may indicate only a, only b, only c, both a and b, both a and c, both b and c, all of a, b, and c, or variations thereof. Similarly, the term “set” means one or more. Accordingly, the set of items may be a single item or a collection of two or more items.

The terms “first”, “second” and the like in the description, claims and the above drawings of the disclosure are used to distinguish similar objects, but not used to describe a specific order or precedence order. It should be understood that the data so used may be interchangeable as appropriate in order that the embodiments of the disclosure described herein may be implemented in an order other than those illustrated or described herein. The embodiments described in the following embodiments do not represent all embodiments consistent with the disclosure. On the contrary, they are only examples of devices and methods consistent with some aspects of the disclosure as detailed in the appended claims.

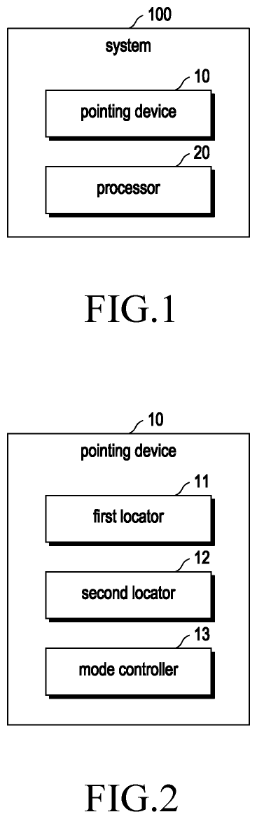

FIG. 1 is a block diagram illustrating a specifying system 100 according to an example embodiment of the disclosure.

Referring to FIG. 1, the specifying system 100 according to an embodiment of the disclosure may include a pointing device 10 and a processor 20. The pointing device 10 may operate in a pointing mode or a control mode, the processor 20 may determine whether the pointing device 10 is in the pointing mode or the control mode, and perform a corresponding operation based on the mode of the pointing device 10. In an example embodiment, when the pointing device 10 is in the pointing mode, the pointing device 10 may be used to specify a virtual object in a virtual space, and at this time, the processor 20 may determine the virtual object that the user wants to specify, according to the pointing of the pointing device 10. In an example embodiment, when the pointing device 10 is in the control mode, the processor 20 may perform a corresponding operation on the virtual object specified by the pointing device 10, according to the control of the pointing device 10. This will be explained in detail below in conjunction with FIGS. 2 to 7.

The processor 20 may correspond to at least one processor (one processor or a combination of processors). The at least one processor includes or corresponds to circuitry like a central processing unit (CPU), a microprocessor unit (MPU), an application processor (AP), a coprocessor (CP), a system-on-chip (SoC), or an integrated circuit (IC).

FIG. 2 is a block diagram illustrating a pointing device 10 according to an example embodiment of the disclosure.

Referring to FIG. 2, the pointing device 10 according to an embodiment of the disclosure may include a first locator 11, a second locator 12, and a mode controller 13.

The pointing of the pointing device 10 may be determined by positions of the first locator 11 and the second locator 12 in a virtual space. For example, the pointing of the pointing device 10 may be a direction in which a connecting line between the positions of the first locator 11 and the second locator 12 extends along a pointing end of the pointing device 10. Here, the first locator 11 and the second locator 12 may be locators using, for example, UWB, Bluetooth™, WiFi™, RFID™, ZigBee™ technology, etc.

The shape of the pointing device 10 may be any shape, for example, pen shape, annular, triangle, etc. For example, if the shape of the pointing device 10 is the pen shape, one of the first locator 11 and the second locator 12 may be set close to the pointing end of the pointing device 10 and the other locator may be set away from the pointing end of the pointing device 10. For another example, if the shape of the pointing device 10 is annular, one of the first locator 11 and the second locator 12 may be set at one of two endpoints of the annular diameter where the pointing end of the pointing device 10 is located, and the other locator may be set at another one of the two endpoints of the annular diameter of the pointing device 10. However, it should be understood that the position settings of the first locator 11 and the second locator 12 are not limited to the above settings, but may be adaptively changed according to the shape of the pointing device 10.

In an example embodiment, the positions of the first locator 11 and the second locator 12 in the space may be obtained in various ways. For example, through the camera positioning method, the positions of the locators may be determined by calculating a plane linear distance between a camera and the locator, and then by coordinate conversion between multiple coordinates. For another example, the positions of the first locator 11 and the second locator 12 may be determined by setting auxiliary locating devices in the space, and the locating devices may use the technologies corresponding to the two locators (such as UWB, Bluetooth, WiFi, RFID, ZigBee technology, etc.) to enable the positioning of the first locator 11 and the second locator 12. At this time, for example, the positions of the first locator 11 and the second locator 12 in the virtual space may be determined according to distances between the first locator 11 and the locating device disposed at a predetermined position in the virtual space and between the second locator 12 and the locating device.

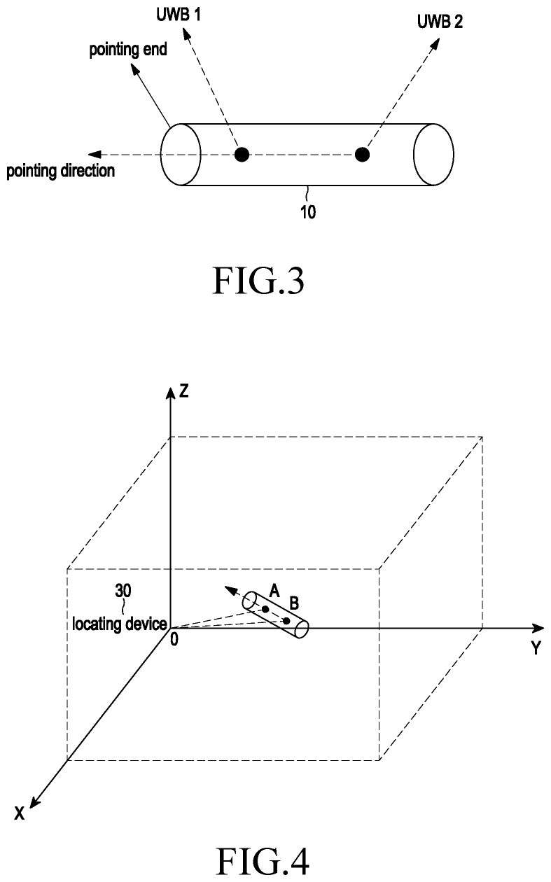

As an example only, when the first locator 11 and the second locator 12 are implemented by using the UWB technology, the locating device may include a UWB receiver or a UWB chip, and both the first locator 11 and the second locator 12 may include a UWB transmitter. At this time, the first locator 11 and the second locator 12 may interact with the locating device in the virtual space respectively, so that the distances between the first locator 11 and the locating device and between the second locator 12 and the locating device may be determined based on transmission delay of data communication between the first locator 11 and the locating device and between the second locator 12 and the locating device, and then the positions of the first locator 11 and the second locator 12 in the virtual space may be further determined based on the distance. The positioning process of the pointing device 10 will be described in detail later in conjunction with FIGS. 3 to 6.

The mode controller 13 may be configured to control the pointing device 10 to operate in one of the control mode and the pointing mode. When the pointing device 10 is in the pointing mode, the pointing device 10 may be used to specify the virtual object in the virtual space, and when the pointing device 10 is in the control mode, the pointing device 10 may be used to control the operation of the virtual object specified by the pointing device 10. For example, the mode controller 13 receives an user input through a button, or other control keys or control means that may control the pointing device 10 to switch modes, and controls the control mode of the pointing device 10 according to the user input, but it is not limited thereto. For example, the pointing device 10 may be provided with a button for controlling mode switching, and when the virtual object is specified, the user may press and hold the button to switch the pointing device 10 from the pointing mode to the control mode, and then the user may operate the pointing device 10 to control the specified virtual object.

FIG. 3 is a diagram illustrating an example configuration of the pointing device 10 according to an example embodiment of the disclosure.

As illustrated in FIG. 3, the two locators in the pointing device 10 may be locators using the UWB technology. Here, the two locators are called UWB1 and UWB2 respectively. The pointing of the pointing device 10 may be the direction in which the connecting line between the positions of UWB1 and UWB2 extends along the pointing end of the pointing device 10, wherein UWB1 is disposed close to the pointing end of the pointing device 10 and UWB2 is disposed away from the pointing end of the pointing device 10.

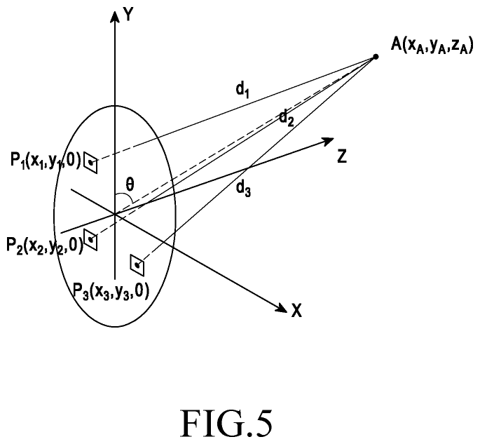

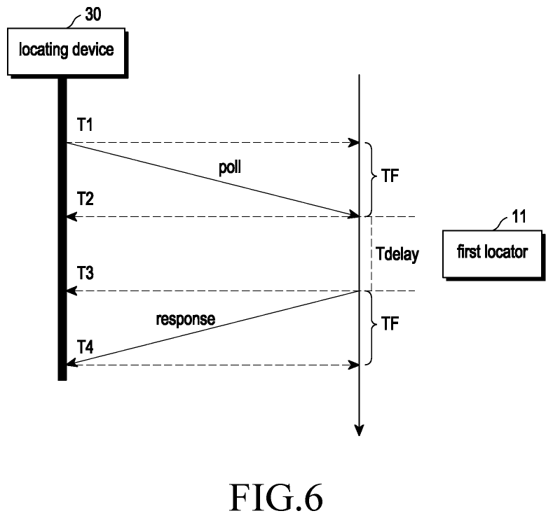

FIG. 4 is a diagram illustrating a coordinate system according to an example embodiment of the disclosure; FIG. 5 is a diagram illustrating determining the coordinates of the first locator 11 according to an example embodiment of the disclosure; and FIG. 6 is a diagram illustrating determining a distance between the first locator 11 and the locating device 30 according to an example embodiment of the disclosure.

As illustrated in FIG. 4, a spatial coordinate system may be established according to the locating device 30, and the locating device 30 may be located at the origin O of the coordinate system. Although the use of a spatial rectangular coordinate system is illustrated in FIG. 4, the coordinate system that may be used in the disclosure may also be a polar coordinate system, a cylindrical coordinate system, etc., in addition, although the origin O of the coordinate system is set as the position of the locating device 30 in FIG. 4, the coordinate system may also be established in other ways, as long as the positions of the first locator 11 and the second locator 12 may be determined by using the locating device 30. Hereinafter, taking the space rectangular coordinate system as an example, calculating the positions of the locators is described.

As an example only, as illustrated in FIG. 5, the locating device 30 may include at least three antennas (antenna 1, antenna 2 and antenna 3) for data communication with the locators of the pointing device 10. An antenna plane where the three antennas of the locating device 30 are located may be disposed parallel to the XY plane in the spatial rectangular coordinate system, but not limited thereto. For example, the antenna plane may also be parallel to the YZ or XZ plane in the spatial rectangular coordinate system. In addition, the antenna plane may not be parallel to any one of the XY, YZ or XZ planes in the spatial rectangular coordinate system.

For example, as illustrated in FIG. 5, when the antenna plane is set parallel to the XY plane in the spatial rectangular coordinate system, the coordinates of antenna 1 in the spatial rectangular coordinate system may be P₁(x₁,y₁,0), the coordinates of antenna 2 in the spatial rectangular coordinate system may be P₂ (x₂,y₂,0), and the coordinates of the antenna 3 in the spatial rectangular coordinate system may be P₃ (x₃,y₃,0). In the example embodiment of the disclosure, the coordinates of antenna 1, antenna 2 and antenna 3 are known.

The process of calculating the coordinates of the first locator 11 and the second locator 12 in the spatial rectangular coordinate system is described below. For ease of description, the first locator 11 may be referred to as a point A in the spatial rectangular coordinate system, and the second locator 12 may be referred to as a point B in the spatial rectangular coordinate system.

First, the processor 20 may determine the positions of the first locator 11 and the second locator 12 disposed in the pointing device 10 in the virtual space.

As illustrated in FIG. 6, when the pointing device 10 is in the pointing mode, the processor 20 may control the three antennas of the locating device 30 to transmit data packets to the first locator 11 and the second locator 12, respectively.

As an example only, the antenna 1 of the locating device 30 may transmit a data packet to the first locator 11 of the pointing device 10 at time T1, the first locator 11 may receive the data packet from the antenna 1 of the locating device 30 at time T2 and transmit a response data packet to the antenna 1 at time T3, and the antenna 1 may receive the response data packet from the first locator 11 at time T4. Here, in FIG. 5, T_{delay} is a time delay between the time T2 when the first locator 11 (point A) receives the data packet and the time T3 when the response data packet is transmitted. T_{delay} may be preset. TF is the time period during which the data packet or the response data packet is transmitted. The response data packet may include information about the time T2 when the locator receives the data packet, information about T_{delay}, and information about the time T3 when the first locator 11 transmits the response data packet.

The processor 20 may calculate the coordinates of the first locator 11 and the second locator 12 in the coordinate system respectively, based on the transmission delay of the data communication between the first locator 11 and the locating device 30 and between the second locator 12 and the locating device 30.

Specifically, the processor 20 may calculate the distance d1 between the point A and the antenna 1 in the coordinate system as follows:

$$\\ {d}_{1} = \frac{( ( {T}_{4} - {T}_{3} ) + ( {T}_{2 -} {T}_{1} ) )}{2} * V$$

wherein V is the speed of the pulse and may be set arbitrarily.

In the same way, the distance d2 between the first locator 11 and the antenna 2, and the distances d3 between the first locator 11 and the antenna 3 may be calculated, respectively.

As illustrated in FIG. 5, since d₁, d₂ and d₃ have been calculated by the above operations, the coordinates (x_{A},y_{A},z_{A}) of point A may be calculated by the following equations (1) to (3):

\sqrt{(x_{A}−x₁)²+(y_{A}−y₁)²+(z_{A}−0)²}=d₁ (1)

\sqrt{(x_{A}−x₂)²+(y_{A}−y₂)²+(z_{A}−0)²}=d₂ (2)

\sqrt{(x_{A}−x₃)²+(y_{A}−y₃)²+(z_{A}−0)²}=d₃ (3)

The coordinates (x_{B},y_{B},z_{B}) of the second locator 12 (point B) may be obtained in the same way as determining the coordinates of the first locator 11 (point A). Accordingly, the processor 20 may calculate the positions (e.g., coordinates) of the first locator 11 and the second locator 12 in the preset coordinate system respectively, according to the distances between the first locator 1 land the locating device 30 disposed at a predetermined position (e.g., origin O (0,0)) in the virtual space and between the second locator 12 and the locating device 30.

According to the coordinates of the first locator 11 and the second locator 12 in the preset coordinate system, a first vector \vec{BA} between the first locator 11 and the second locator 12 may be calculated. That is, after the coordinates (x_{A}, y_{A}, z_{A}) of the point A and the coordinates (x_{B}, y_{B}, z_{B}) of the point B are determined by the above calculating, the value of the vector \vec{BA} (m, n, p) may be obtained (referring to FIG. 4).

Values of m, n and p of the vector (m, n, p) may be calculated according to equations (4) to (6) as follows:

m=x_{A}−x_{B} (4)

n=y_{A}−y_{B} (5)

p=z_{A}−z_{B} (6)

Accordingly, the processor 20 may determine the pointing of the pointing device 10 according to the positions of the first locator 11 and the second locator 12. As illustrated in FIG. 4, the direction of the vector \vec{BA} may be determined as the pointing of pointing device 10.

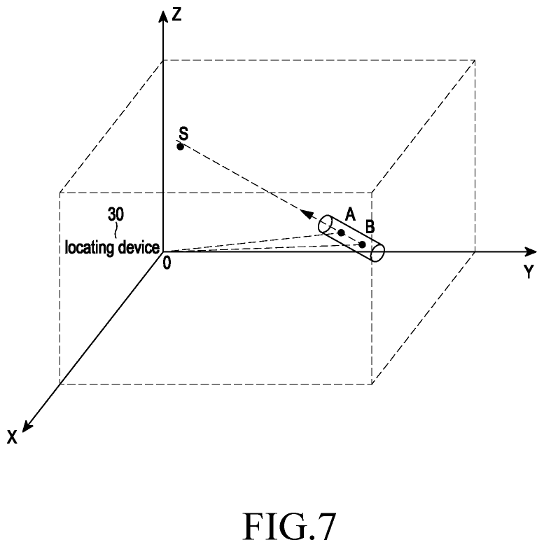

FIG. 7 is a diagram illustrating determining the specified virtual object according to an example embodiment of the disclosure.

Whether the virtual object is specified may be determined by determining whether the coordinate of the virtual object S(Xₛ, Yₛ, Zₛ) is on an extension line of the vector \vec{BA}. When the coordinate of the virtual object S(Xₛ, Yₛ, Zₛ) is on the extension line of the vector \vec{BA}, it is determined that the virtual object is specified. That is, the processor 20 may determine the virtual object located in the pointing direction of the pointing device 10 as the specified virtual object.

First, the processor 20 may calculate a second vector between one locator of the first locator 11 and the second locator 12 and each virtual object in the virtual space. For example, a vector \vec{BS} (h,k,l) related to the virtual object S may be obtained according to equations (7) to (9) as follows:

h=Xₛ−x_{B} (7)

k=Yₛ−y_{B} (8)

1=Zₛ−z_{B} (9)

Then, an angle between the second vector \vec{BS} and the first vector \vec{BA} is calculated. Whether \vec{BA} and \vec{BS} are on a line is determined by calculating the angle α of these two vectors \vec{BA} and \vec{BS}. For example, cos a may be obtained by the following formulas (10) and (11), and then a value of a may be obtained:

$$\\ \begin{matrix}cos α = \frac{\vert {BA}^{⟶} \vert * \vert {BS}^{⟶} \vert}{{BA}^{⟶} * {BS}^{⟶}} & ( 10 )\end{matrix}$$

$$\\ \begin{matrix}α = arc cos \frac{\vert {BA}^{⟶} \vert * \vert {BS}^{⟶} \vert}{{BA}^{⟶} * {BS}^{⟶}} & ( 11 )\end{matrix}$$

The processor 20 may determine the virtual object located in the pointing direction of the pointing device 10 as the specified virtual object. That is, if α=0, A, B and S are on the same line, which represents that the user specifies the virtual object S.

Alternatively, the processor 20 may also determine the virtual object located near the pointing direction of the pointing device 10 as the specified virtual object. For example, the processor 20 may determine the virtual object having the angle α with the first vector \vec{BA} being within a preset range, as the specified virtual object, that is, if the calculated α is within the preset range, this may also represent that the user specifies the virtual object S. Here, the preset range may be preset. For example, when α<10°, it represents that the user specifies this virtual object S.

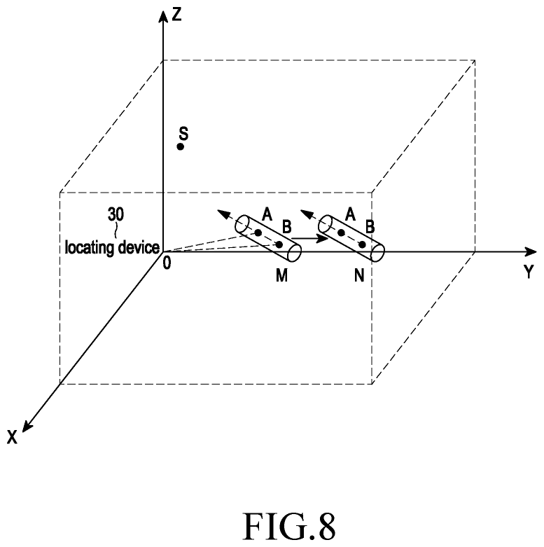

FIG. 8 is a diagram illustrating that the pointing device 10 according to an example embodiment of the disclosure is moved.

The pointing device 10 may be provided with a button for controlling mode switching. When the virtual object is specified, the user may press and hold the button to switch the pointing device 10 from the pointing mode to the control mode, and then the user may operate the pointing device 10 to control the specified virtual object, wherein the operation may be any preset operation, such as rotation, moving to right and moving to left, etc. When the pointing device 10 is switched to the control mode, the processor 20 may perform a corresponding operation on the virtual object specified by the pointing device 10 based on the control of the pointing device 10.

The user may customize the operation of the virtual object corresponding to the change of the pointing of the pointing device 10. For example, as illustrated in FIG. 8, the user may set that, when the pointing device 10 moves to right, the specified virtual object is dragged to right. Such an operation may be set according to user preferences.

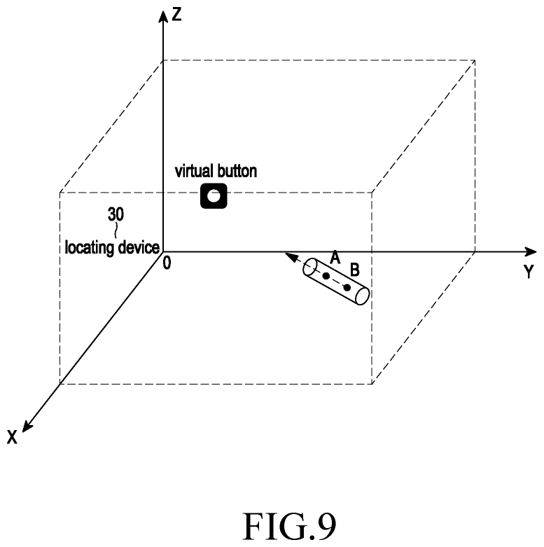

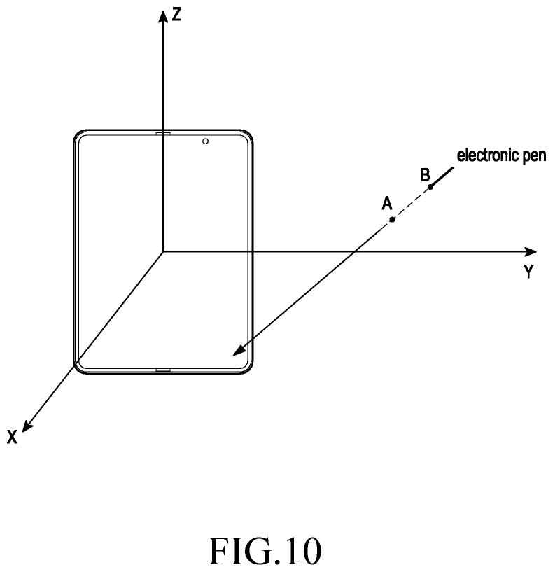

The specifying system 100 described above with reference to FIGS. 4 to 8 may be applied to various intelligent apparatus (such as smart phones, smart blackboards, etc.), which will be explained below in conjunction with FIGS. 9 and 10.

FIG. 9 is an example diagram illustrating that the specifying system 100 according to an example embodiment of the disclosure is applied to an augmented reality (AR) scene experience.

As illustrated in FIG. 9, the locating device 30 may be a beacon, and two locators (e.g., the first locator 11 and the second locator 12 described above) may be disposed in the pointing device 10 (such as a ring).

The rectangular coordinate system may be established in virtual space with beacon. The user may point to a virtual button as illustrated in FIG. 9 by moving or rotating the pointing device 10 in the pointing mode, using, for example, the pointing device 10 including two UWB. The processor 20 (e.g., a server) may calculate the value of the vector \vec{BA} in real time, and determine whether the pointing device 10 points to the virtual button. When it is determined that the pointing device 10 points to the virtual button, the virtual button highlights and shows a prompt tone. Then, by clicking the preset button of the pointing device, the mode of the pointing device 10 may be switched from the pointing mode to the control mode, in addition, for example, if it is also preset that music will play when clicking the button of the pointing device, the music will play at this time.

FIG. 10 is an example diagram illustrating that the specifying system 100 according to an example embodiment of the disclosure is applied to a smart apparatus.

As illustrated in FIG. 10, the smart apparatus may include a main part (e.g., an electronic device including a screen) and an electronic pen separated from the main part, wherein the main part may be provided with the locating device 30, and the electronic pen may be provided with two locators (e.g., the first locator 11 and the second locator 12 described above).

The spatial rectangular coordinate system may be established according to the position of the locating device 30 of the main part. When the user points to a certain application APP (such as a camera) in the main part with the electronic pen, the smart apparatus may calculate the value of the vector \vec{BA} in real time, according to the positions of the two locators in the electronic pen. When it is determined that the electronic pen points to the APP according to the value of the vector \vec{BA} (the position of the APP in the spatial rectangular coordinate system may be determined by the processor 20), the user may switch the electronic pen from the pointing mode to the control mode, and control the APP according to the operation of the electronic pen, for example, if the electronic pen is moved back and forth twice, it represents the APP is clicked.

In addition, the above smart apparatus may also be a smart blackboard. In the similar manner as above, a spatial rectangular coordinate system may be established according to the smart blackboard, and a teacher may operate the content on the blackboard with a device similar to the electronic pen, for example, write remotely.

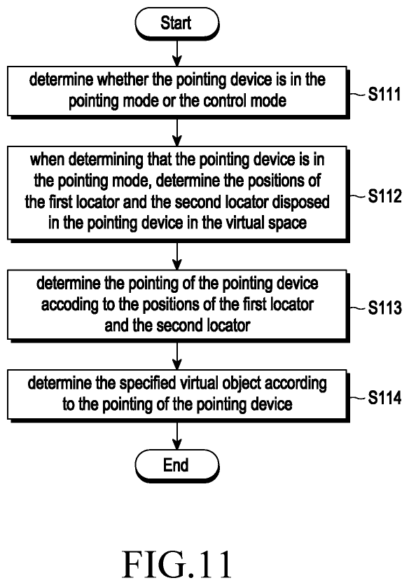

FIG. 11 is a flowchart illustrating a method of specifying an object according to an example embodiment of the disclosure.

In operation S111, the processor 20 determines whether the pointing device 10 is in the pointing mode or the control mode.

In operation S112, the processor 20, when determining that the pointing device 10 is in the pointing mode, determines the positions of the first locator 11 and the second locator 12 disposed in the pointing device 10 in the virtual space.

In operation S113, the processor 20 may determine the pointing of the pointing device 10 according to the positions of the first locator 11 and the second locator 12.

In operation S114, the processor 20 may determine the specified virtual object according to the pointing of the pointing device 10.

The above operations have been described in detail in connection with FIGS. 4 to 7, and will not be repeated here.

Previous technologies may realize the interaction with the virtual object or remote operation to the virtual object, but only for the whole, and may not precisely point to a certain virtual object within the space or in the screen from a long distance, and then interact with it alone. According to the example embodiment of the disclosure, the virtual space may be more realistic by the pointing device including the first locator and the second locator precisely pointing to the virtual object within the virtual space from a long distance, and then interacting with the specified virtual object through user-defined settings. In the example embodiment of the disclosure, the user may interact with a single virtual object in the virtual space, so that the sense of immersion of the user is increased. The pointing device according to the embodiment of the disclosure requires only two locators (for example, the UWB1 and the UWB2 described above), such a design is cheap and simple. In addition, by disposing two locators in the electronic pen of the smart apparatus, the electronic pen of the smart apparatus is more practical, and the interaction with various information within the screen may be realized without closely clicking on the screen.

The processor (e.g., the processor 20) may be implemented by artificial intelligence (AI) model. The functions associated with AI may be performed by a nonvolatile memory, a volatile memory and a processor.

The processor (e.g., the processor 20) may include one or more processors. At this time, the one or more processors may be general-purpose processors, for example, a central processing unit (CPU), an application processor (AP), etc., and a processor only for graphics (for example, graphics processor (GPU), visual processor (VPU), and/or AI dedicated processors (for example, neural processing unit (NPU)).

The one or more processors control the processing of input data according to a predefined operating rule or artificial intelligence (AI) model stored in nonvolatile memory and volatile memory. The predefined operating rules or artificial intelligence model may be provided by training or learning. Here, the provided by learning means that the predefined operating rules or AI model with desired characteristics are formed by applying the learning algorithm to a plurality of learning data. The learning may be performed in the apparatus itself performing AI according to the embodiment, and/or may be implemented by a separate server/apparatus/system.

As an example, the artificial intelligence model may be composed of multiple neural network layers. Each layer has multiple weight values, and the layer operation is performed through the calculation of the previous layer and the operation of multiple weight values. Examples of neural networks include but are not limited to convolutional neural network (CNN), deep neural network (DNN), recursive neural network (RNN), restricted Boltzmann machine (RBM), depth confidence network (DBN), bidirectional recursive depth neural network (BRDNN), generative countermeasure network (GAN) and depth Q network.

A learning algorithm is a method of using a plurality of learning data to train a predetermined target apparatus (e.g., a robot) to make, allow or control the target apparatus to make a determination or prediction. Examples of the learning algorithm include but are not limited to supervised learning, unsupervised learning, semi supervised learning or reinforcement learning.

According to the disclosure, in the method of specifying the virtual object in the virtual space, the method of inferring or predicting the position of the locator may be performed using the artificial intelligence model. The processor may perform a preprocessing operation on the data to convert it into a form suitable for use as the artificial intelligence model input.

The artificial intelligence model may be obtained through training Here, “obtained through training” refers to training the basic artificial intelligence model with multiple training data through the training algorithm, thereby obtaining the predefined operation rule or artificial intelligence model, which is configured to perform the required feature (or purpose).

As an example, the artificial intelligence model may include a plurality of neural network layers. Each of the plurality of neural network layers includes a plurality of weight values, and neural network calculation is performed by calculation between the calculation result on the previous layer and the plurality of weight values.

Inference and prediction is a technology of logical inferring and predicting by determined information, including, for example, knowledge-based inference, optimization prediction, preference based planning or recommendation.

As an example, the smart apparatus may be a PC computer, a tablet device, a personal digital assistant, a smart phone, or other device capable of performing the above method. Here, the smart apparatus does not have to be a single electronic apparatus, but may also be any aggregate of devices or circuits capable of performing the above method alone or jointly. The smart apparatus may also be a part of an integrated control system or system manager, or a portable electronic apparatus that may be configured to interface with a local or remote (e.g., via wireless transmission).

In the electronic apparatus, the processor (for example, the processor 20, the mode controller 13) may include a central processing unit (CPU), a graphics processor (GPU), a programmable logic device, a dedicated processor system, a microcontroller or a microprocessor. As an example rather than a limitation, the processor may also include an analog processor, a digital processor, a microprocessor, a multi-core processor, a processor array, a network processor, etc.

The processor may execute instructions or code stored in memory, wherein the memory may also store data. Instructions and data may also be transmitted and received through the network via a network interface device, wherein the network interface device may adopt any known transmission protocol.

The memory may be integrated with the processor, for example, by arranging RAM or flash memory within an integrated circuit microprocessor, etc. In addition, the memory may include an independent device, such as external disk drives, storage arrays, or other storage devices that may be used by any database system. The memory and the processor may be operatively coupled, or may communicate with each other, for example, through input/output (I/O) ports, network connection and the like, so that the processor is capable of reading files stored in the memory.

In addition, the electronic apparatus may also include a video display (such as a liquid crystal display) and a user interaction interface (such as a keyboard, mouse, touch input device, etc.). All components of the electronic apparatus may be connected to each other via a bus and/or network.

According to an embodiment of the disclosure, a computer readable storage medium for storing instructions may also be provided, wherein the instructions, when executed by at least one processor, cause at least one processor to perform the method according to the example embodiment of the disclosure. Examples of the computer readable storage medium herein include read only memory (ROM), random access programmable read only memory (PROM), electrically erasable programmable read only memory (EEPROM), random access memory (RAM), dynamic random access memory (DRAM), static random access memory (SRAM), flash memory, non-volatile memory, CD-ROM, CD-R, CD+R, CD-RW, CD+RW, DVD-ROM, DVD-R, DVD+R, DVD-RW, DVD+RW, DVD-RAM, BD-ROM, BD-R, BD-R LTH, BD-RE, Blue ray or optical disk memory, hard disk drive (HDD), solid state hard disk (SSD), card memory (such as multimedia card, secure digital (SD) card or extreme speed digital (XD) card), magnetic tape, floppy disk, magneto-optical data storage device, optical data storage device, hard disk, solid-state disk and any other device configured to store computer program and any associated data, data file and data structure in a non-transitory manner and to provide the computer program and any associated data, data file and data structure to the processor or the computer so that the processor or the computer program is capable of performing the computer program.

A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

The computer program in the computer readable storage medium described above may run in an environment deployed in the computer apparatus such as a client, a host, a proxy apparatus, a server, etc. In addition, in one example, the computer program and any associated data, data file and data structures are distributed on a networked computer system, so that the computer programs and any associated data, data file and data structure are stored, accessed and executed in a distributed manner through one or more processors or computers.

According to an embodiment of the disclosure, a computer program product may also be provided, of which instructions may be executed by at least one processor in an electronic apparatus, to perform a method according to an example embodiment of the disclosure.

After considering the description and practicing the present disclosure disclosed herein, those skilled in the art easily conceive of other embodiments of the disclosure. The application is intended to cover any variant, use or adaptive changes of the disclosure, which follow the general principles of the disclosure and include the common knowledge or customary technical means in the technical field which is not disclosed in the disclosure. The description and embodiments are only regarded as example, and the true scope and spirit of the disclosure are pointed out by the claims.

The disclosure is not limited to the example embodiments described above and illustrated in the drawings, and various modifications and changes may be made therein without departing from its scope. The scope of the disclosure is limited only by the claims.

What is claimed is:

1. A method for specifying an object, the method comprising:
determining whether a pointing device is in a pointing mode or a control mode;
determining a first position of a first locator and a second position of a second locator in the pointing device in a virtual space, when the pointing device is in the pointing mode;
determining pointing of the pointing device based on the first position of the first locator and the second position of the second locator; and
determining a specified virtual object based on the pointing of the pointing device.

2. The method of claim 1, wherein the determining the pointing of the pointing device comprises determining a direction in which a connecting line between the first position of the first locator and the second position of the second locator extends along a pointing end of the pointing device, as the pointing of the pointing device, and
wherein the determining the specified virtual object comprises determining the virtual object located in the direction of the pointing device as the specified virtual object.

3. The method of claim 2, wherein the determining the first position of the first locator and the second position of the second locator in the pointing device in the virtual space comprises determining the first position of the first locator and the second position of the second locator in a preset coordinate system, respectively, based on a first distance between the first locator and a locating device in a predetermined position in the virtual space and a second distance between the second locator and the locating device.

4. The method of claim 3, wherein the locating device comprises a ultra wideband (UWB) receiver or a UWB chip,
wherein both of the first locator and the second locator comprise a UWB transmitter, and
wherein the determining the first position of the first locator and the second position of the second locator in the preset coordinate system comprises determining a first coordinate of the first locator and a second coordinate of the second locator in the preset coordinate system, respectively, based on a first transmission delay of a data communication between the first locator and the locating device and a second transmission delay of the data communication between the second locator and the locating device.

5. The method of claim 4, wherein a first vector between the first locator and the second locator is determined based on the first coordinate of the first locator and the second coordinate of the second locator in the preset coordinate system.

6. The method of claim 5, wherein the determining the specified virtual object comprises:
determining a second vector between one of the first locator and the second locator and a virtual object in the virtual space;
determining an angle between the second vector and the first vector; and
determining the virtual object having the angle with the first vector being within a preset range as the specified virtual object.

7. The method of claim 2, further comprises:
determining whether the pointing device is switched to the control mode, when the virtual object is specified; and
performing a corresponding operation on the virtual object specified by the pointing device, based on the control of the pointing device, after the pointing device is switched to the control mode.

8. A pointing device comprising:
a first locator;
a second locator; and
a mode controller configured to control the pointing device to selectively operate in a pointing mode for specifying a virtual object in a virtual space and a control mode for controlling operation of the virtual object specified by the pointing device,
wherein pointing of the pointing device is determined based on positions of the first locator and the second locator in the virtual space.

9. A specifying system comprises:
a pointing device comprising a first locator and a second locator; and
a processor configured to:
determine whether the pointing device is in a pointing mode or a control mode,
determine a first position of the first locator and a second position of the second locator in a virtual space, when the pointing device is in the pointing mode,
determine pointing of the pointing device based on the first position of the first locator and the second position of the second locator, and
determine a specified virtual object based on the pointing of the pointing device.

10. The specifying system of claim 9, wherein the processor is further configured to:
determine a direction in which a connecting line between the first position of the first locator and the second position of the second locator extends along a pointing end of the pointing device, as the pointing of the pointing device, and
determine a virtual object located in the direction of the pointing device as the specified virtual object.

11. The specifying system of claim 10, wherein the processor is further configured to determine the first position of the first locator and the second position of the second locator in a preset coordinate system, respectively, based on a first distance between the first locator and a locating device in a predetermined position in the virtual space and a second distance between the second locator and the locating device.

12. The specifying system of claim 11, wherein the locating device comprises a ultra wideband (UWB) receiver or a UWB chip,
wherein each of the first locator and the second locator comprises a UWB transmitter, and
wherein the processor is further configured to determine a first coordinate of the first locator and a second coordinate of the second locator in the preset coordinate system, respectively, based on a first transmission delay of data communication between the first locator and the locating device and a second transmission delay between the second locator and the locating device.

13. The specifying system of claim 12, wherein a first vector between the first locator and the second locator is determined based on the first coordinate of the first locator and the second coordinate of the second locator in the preset coordinate system.

14. The specifying system of claim 10, wherein, when the virtual object is specified by the pointing device, the processor is further configured to determine whether the pointing device is switched to the control mode, and
wherein, after the pointing device is switched to the control mode, the processor is further configured to perform a corresponding operation on the virtual object specified by the pointing device based on control of the pointing device.

15. A non-transitory computer-readable storage medium having stored computer program instructions thereon, the computer program instructions configured to, when executed by a processor of an electronic apparatus, cause the electronic apparatus to:
determine whether a pointing device is in a pointing mode or a control mode;
determine positions of a first locator and a second locator disposed in the pointing device in a virtual space, when the pointing device is in the pointing mode;
determine pointing of the pointing device according to the positions of the first locator and the second locator; and
determine the specified virtual object according to the pointing of the pointing device.

16. The non-transitory computer-readable storage medium of claim 15, wherein the computer program instructions are configured to, when executed by the processor, causing the electronic apparatus to:
determine a direction in which a connecting line between the positions of the first locator and the second locator extends along a pointing end of the pointing device, as the pointing of the pointing device,
determine a virtual object located in the pointing direction of the pointing device as the specified virtual object, and
calculate the positions of the first locator and the second locator in a preset coordinate system, respectively, according to distances between the first locator and a locating device disposed in a predetermined position in the virtual space and between the second locator and the locating device.

17. The non-transitory computer-readable storage medium of claim 15, wherein the locating device comprises a UWB receiver or a UWB chip, and both the first locator and the second locator include a UWB transmitter,
wherein the computer program instructions configured to, when executed by a processor of an electronic apparatus, causing the electronic apparatus to:
calculate coordinates of the first locator and the second locator in the preset coordinate system, respectively, based on transmission delay of data communication between the first locator and the locating device and between the second locator and the locating device.

18. The non-transitory computer-readable storage medium of claim 17, wherein a first vector between the first locator and the second locator is calculated according to the coordinates of the first locator and the second locator in the preset coordinate system.

19. The non-transitory computer-readable storage medium of claim 18, wherein the computer program instructions configured to, when executed by a processor of an electronic apparatus, causing the electronic apparatus to:
calculate a second vector between one locator of the first locator and the second locator and each virtual object in the virtual space;
calculate an angle between the second vector and the first vector; and
determine the virtual object of which the angle with the first vector is within a preset range as the specified virtual object.

20. The non-transitory computer-readable storage medium of claim 15, wherein the computer program instructions are configured to, when executed by the processor, cause the electronic apparatus to:
determine whether the pointing device is switched to the control mode, when the virtual object is specified; and
perform a corresponding operation on the virtual object specified by the pointing device, based on the control of the pointing device, after the pointing device is switched to the control mode.
